(19) United States
(12) Patent Application Publication
(10) Pub. No.: US 2014/0086541 A1
(43) Pub. Date: Mar. 27, 2014

(54) OPTICAL MODULE

(71) Applicant: SUMITOMO ELECTRIC INDUSTRIES, LTD., Osaka-shi, Osaka (JP)

(72) Inventor: Hajime Arao, Yokohama-shi (JP)

(21) Appl. No.: 14/122,252

(22) PCT Filed: Nov. 27, 2012
(86) PCT No.: PCT/JP2012/080619

§ 371 Date: Nov. 26, 2013

(30) Foreign Application Priority Data
Dec. 28, 2011 (JP) 2011-289476

(51) Int. Cl. G02B 6/42

(52) U.S. Cl. CPC G02B 6/4251; G02B 6/4284; G02B 6/4269
USPC 385/92

(57) ABSTRACT

In an optical module 10 in which a connector unit 30 is provided at an end portion of an optical cable 20 including an optical fiber 22, the connector unit 30 includes an inner housing 311 accommodating a circuit substrate to which an electrical connector is connected at a front end portion, and an outer housing 312 covering an outside of the inner housing 311. A step portion 343 is provided on the inner housing 311, an internal space S on a side of the front end portion from the step portion 343 of the inner housing 311 is narrower than an internal space S on a side of a rear end portion from the step portion 343, and a predetermined gap is formed between the inner housing 311 and the outer housing 312.

### TECHNICAL FIELD

The present invention relates to an optical module in which a connector unit is provided at an end portion of an optical cable.

### BACKGROUND ART

An optical module that carries out a photoelectric conversion of an optical signal transmitted through an optical cable has been known (for example, see Patent Literature 1). The aforementioned optical module is, for example, configured to include a metal casing (metal housing) of which an outside is covered by a resin housing, the metal casing accommodating a circuit substrate where an element or the like that carries out the photoelectric conversion of an optical signal is provided.

### CITATION LIST

### Patent Literature

[Patent Literature 1] JP-A-2010-010254

### SUMMARY OF INVENTION

### Technical Problem

However, in an optical module of Patent Literature 1, dusts may enter a gap between an outside resin housing and an inside metal housing. Accordingly, there is concern that dusts enter the inner part of the housing from the gap of the metal housing and adhere onto a circuit substrate or the like.

The present invention is to provide an optical module that can prevent dusts, which have entered the gap between the inner housing accommodating the circuit substrate and the outer housing, from intruding further into the depth of the gap.

An optical module according to the invention is an optical module in which a connector unit is provided at an end portion of an optical cable including an optical fiber,

wherein the connector unit includes
an inner housing accommodating a circuit substrate in which an optical element, to which an end portion of the optical fiber is optically connected, is provided and to which an electrical connector is connected at a front end portion; and
an outer housing covering an outside of the inner housing,

wherein a step portion is provided on the inner housing,

wherein an internal space on a side of the front end portion from the step portion of the inner housing is narrower than an internal space on a side of a rear end portion from the step portion of the inner housing, and
wherein a predetermined gap is formed between the inner housing and the outer housing.

Further, in the optical module according to the invention, it is preferable that an optical coupling member optically connecting the optical fiber and the optical element, which have different optical axes from each other, is provided on the circuit substrate, and the height of the optical coupling member is greater than the distance between the circuit substrate and the inner housing on the side of the front end portion.

Furthermore, in the optical module according to the invention, it is preferable that a sealing member, which has a smaller young's modulus than that of the inner housing, is attached between the inner housing and the electrical connector, and the inner housing and the electrical connector are provided being in contact with the sealing member.

Further, in the optical module according to the invention, it is preferable that a cut-and-raised second engagement portion engaging with a first engagement portion provided on an inner surface of the outer housing is provided on a wall surface of the inner housing, the step portion is provided on the side of the front end portion from a cut-and-raised hole formed due to the second engagement portion, and a gap between the wall surface and the outer housing on a side of a rear end portion of the connector unit from the step portion is narrower than a gap between the wall surface and the outer housing on a side of a front end portion of the connector unit from the step portion.

Furthermore, in the optical module according to the invention, it is preferable that the step portion is provided on a wall surface of the inner housing on the side of the front end portion from the accommodation space where the optical element is provided.

Further, in the optical module according to the invention, it is preferable that a heat radiation member, thermally connecting the circuit substrate and the inner housing, is provided on the inner side of the wall surface including the cut-and-raised hole in the inner housing.

According to the optical module of the invention, it is possible to prevent dusts, which have entered the gap between the inner housing accommodating the circuit substrate and the outer housing, from intruding further into the depth of the gap.

### BRIEF DESCRIPTION OF DRAWINGS

FIG. 1 is a perspective view of an optical module according to an embodiment of the present invention.

FIG. 2 is a cross-sectional view of the optical cable.

FIG. 3 is an exploded perspective view of a connector module.

FIG. 4 is a cross-sectional view of the optical module along the longitudinal direction.

FIG. 5 is a cross-sectional view illustrating a front end portion of the connector module and an enlarged view of the part circled with a broken line in the view.

FIG. 6(A) is a plan view of a connection part of the optical cable and the connector module, and FIG. 6(B) is a side view of a circuit substrate.

FIG. 7 is a schematic cross-sectional view illustrating a modified example of an optical coupling member.

### DESCRIPTION OF EMBODIMENT

Hereinafter, an example of an embodiment of an optical module according to the present invention will be described in reference to the views.

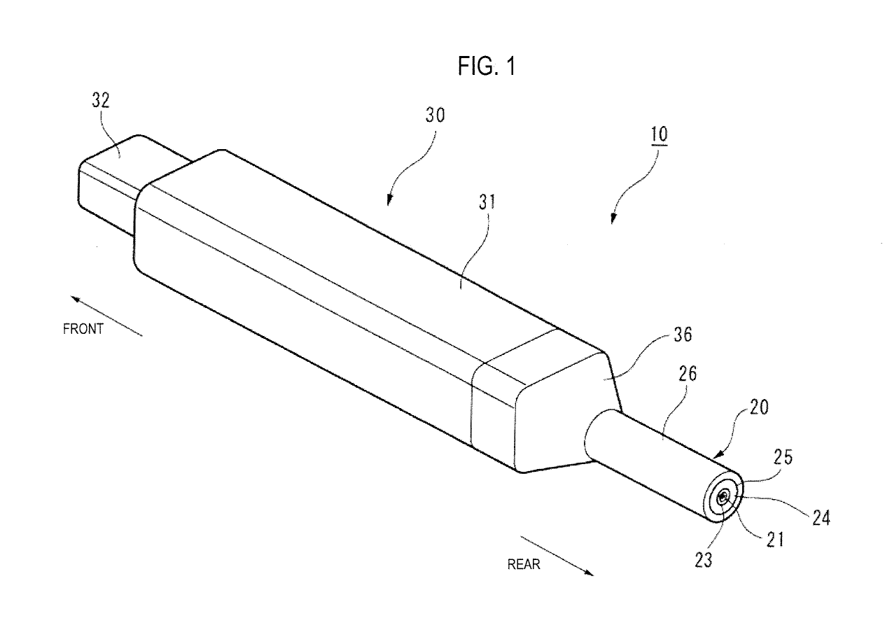

As illustrated in FIG. 1, an optical module 10 according to the embodiment has an optical cable 20 and a connector module (connector unit) 30 attached to an end portion of the optical cable 20.

The optical module 10 can be employed in transmitting of signals (data) in optical communication technology so as to be electrically connected to an electronic device such as a personal computer at an access point, and convert an input/output electrical signal into an optical signal, thereby transmitting the optical signal.

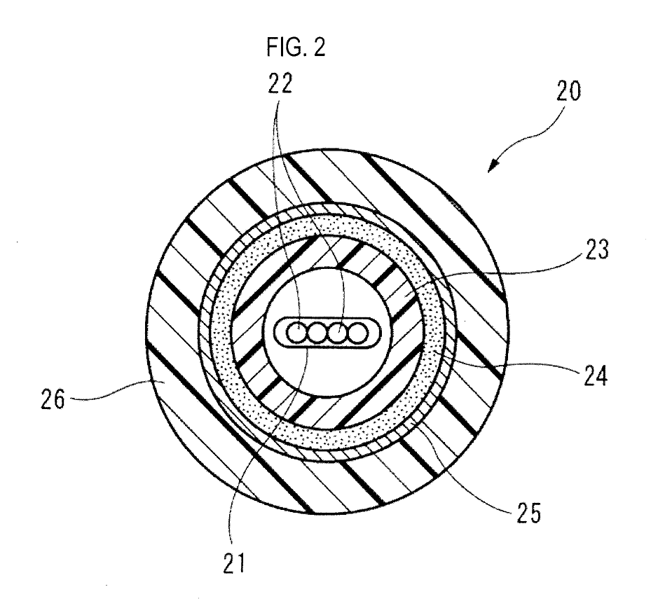

As illustrated in FIGS. 1 and 2, the optical cable 20 has an optical fiber ribbon 21 in the center when viewed in a cross section thereof. The optical fiber ribbon 21 has a configuration in which a plurality (four in the example) of coated optical fibers (optical fibers) 22 are arranged in parallel on a plane so as to be integrated with a coating resin in a tape shape. The optical fiber ribbon 21 is accommodated inside an inner tube 23.

An interposing layer 24 formed of bundles of tensile strength fibers is provided around the inner tube 23. A metal layer 25 formed of a plurality of metal element wires is provided on the outer periphery of the interposing layer 24. A jacket 26 formed of an insulating resin is provided on the outer periphery of the metal layer 25.

As the coated optical fiber 22, an optical fiber of which a core and a cladding are made of silica glass (All Glass Fiber: AGF), an optical fiber of which the cladding is made of rigid plastic (Hard Plastic Clad Fiber: HPCF) can be employed. If a thin diameter HPCF having a glass core diameter of 80 μm is employed, the coated optical fiber 22 is difficult to be broken, even when the coated optical fiber 22 is bent in a circle having a small diameter.

It is possible to accommodate a plurality of coated optical fibers 22 that are not tape-type but in single fibers inside the inner tube 23. However, if the coated optical fibers are tape-type, it is possible to prevent a microbending loss from being generated due to an exerted lateral pressure of the coated optical fiber 22 in the single fibers crossing each other. Further, the optical fiber ribbon 21 may be provided in a plural number.

The inner tube 23 is made of an insulating resin such as, for example, polyvinylchloride (PVC) which is a non-halogen flame retardant resin. For example, the inner tube 23 has an outer diameter of 2.0 mm and a thickness of 0.55 mm.

The interposing layer 24 is, for example, an aramid fiber having an ultrafine diameter, and built in the optical cable 20 in a bundled assembly state. The interposing layer 24 has a tensile strength function with respect to the optical cable 20.

The metal layer 25 is, for example, a layer braided with a plurality of tin-plated lead wires and has a function as a heat radiation layer. The metal layer 25 is equal to or more than 70% in braid density, and 45° to 60° in a braid angle. The outer diameter of the metal element wire configuring the metal layer 25 is approximately 0.05 mm. Thermal conductivity of the metal layer 25 is, for example, 400 W/m·K. It is preferable that the metal layer 25 be arranged at high density to secure satisfactory thermal conductivity. As an example, it is preferable that the thermal layer 25 be configured with a rectangular tin-plated lead wire.

The jacket 26 is formed of an insulating resin such as, for example, polyolefin. For example, the jacket 26 has the outer diameter of 4.2 mm and the thickness of 0.5 mm.

The optical cable 20 having the above-described configuration excels in a lateral pressure characteristic of the coated optical fiber 22 and flexibility as a cable, and excels in heat radiation as well.

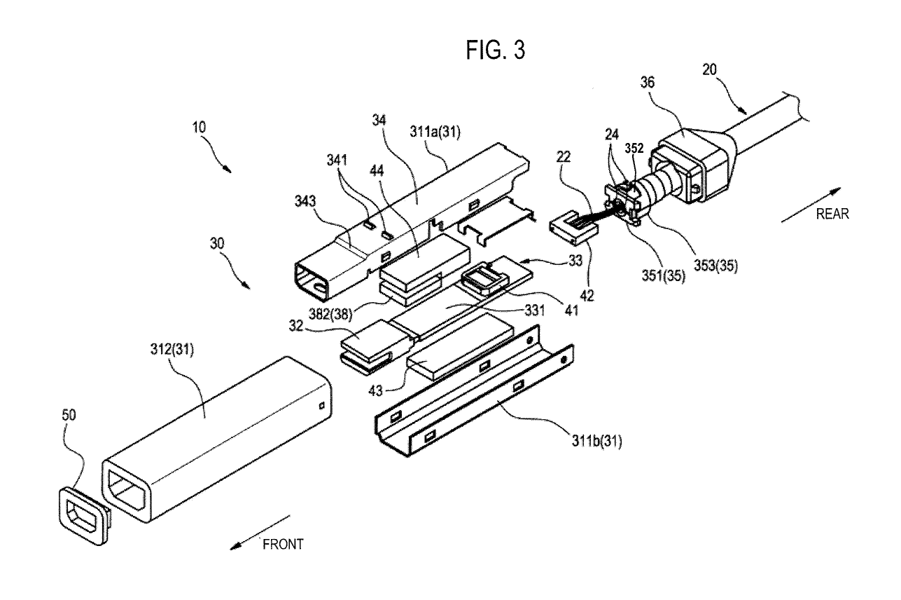

As illustrated in FIG. 1, the connector module 30 includes a housing 31, an electrical connector 32 provided on a side of a front end portion (left end in FIG. 1) of the housing 31, and a circuit substrate 33 (see FIG. 3) accommodated in the housing 31.

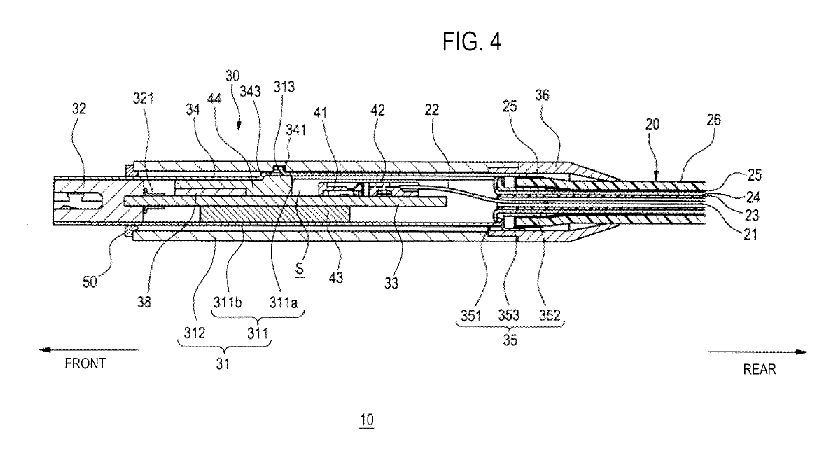

As illustrated in FIGS. 3 and 4, the housing 31 is configured to include a metal housing (inner housing) 311, and a resin housing (outer housing) 312 covering an outside of the metal housing 311. In addition, a fixing member 35 fixing the optical cable 20 is attached to the rear end portion of the metal housing 311.

The metal housing 311 has a cross-sectional U-shaped accommodation portion main body 311a open downward and a cross-sectional U-shaped base plate 311b open upward to form an internal space S accommodating the circuit substrate 33 or the like. In addition, the electrical connector 32 is provided on the side of the front end portion of the circuit substrate 33 to be accommodated on the side of the front end portion of the metal housing 311. The fixing member 35 is attached on the side of the rear end portion of the metal housing 311. In the embodiment, the metal housing 311 is made of a metal material having high thermal conductivity (preferably equal to or more than 100 W/m·K) such as steel (Fe-based), tin (tin-plated copper), stainless steel, copper, brass or aluminum, thereby serving to outwardly radiate heat generated from the circuit substrate 33 or the like.

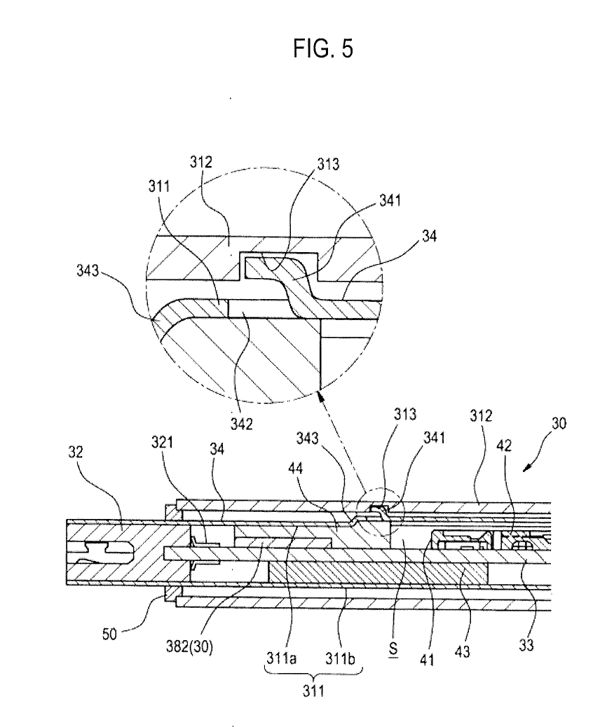

As illustrated in FIG. 5, an engagement convex portion (second engagement portion) 341 cut to be raised is provided on a wall surface of the metal housing 311 (for example, top plate 34 of the accommodation portion main body 311a), and a cut-and-raised hole 342 is formed directly below the engagement convex portion 341 (see enlarged view in FIG. 5). In addition, a step portion 343, tilted upwardly toward the side of the rear end portion from the side of the front end portion of the connector module 30, is provided on the side of the front end portion of the top plate 34 from the cut-and-raised hole 342. That is, the metal housing 311 is provided with the step portion 343 such that the opening on the side of the front end portion becomes narrow, and then a predetermined gap is formed between the metal housing 311 and the resin housing 312. Then, a gap between the top plate 34 and the resin housing 312 on the side of the rear end portion from the step portion 343 is narrower than a gap between the top plate 34 and the resin housing 312 on the side of the front end portion from the step portion 343.

Moreover, a sealing member 50, which is formed of a material having a smaller young's modulus than that of the metal housing 311, is attached between the metal housing 311 and the electrical connector 32. Both the metal housing 311 and the electrical connector 32 are provided being in contact with the sealing member 50. In the aforementioned configuration, dusts are prevented from intruding between the metal housing 311 and the resin housing 312. Further, even though an external force is added to the optical module 10 in a state where the electrical connector 32 is connected to an external device, since the external force is absorbed by the elastic sealing member 50 having a smaller young's modulus, it is possible to prevent damage to the metal housing 311. However, in this case, a gap may occur between the metal housing 311 and the electrical connector 32, and the resin housing 312 such that dusts may enter between the metal housing 311 and the resin housing 312. A further advantageous effect of the invention in the aforementioned case will be described below.

In the embodiment, the step portion 343 of the metal housing 311 is provided on the top plate 34 on the side of the front end portion from a below-described lens array component 41 (one example of an optical coupling member) accommodated in the internal space S (one example of an accommodation space) of the metal housing 311. In this way, the step portion 343 can prevent dusts, having entered the space between the metal housing 311 and the resin housing 312 from the side of the front end portion, from further intruding while the internal space S to accommodate the lens array component 41 is enlarged. That is, even in a case where the height of the lens array component 41 is greater than the distance (typically, distance from the circuit substrate 33 to upper end of electrical connector 32) from the circuit substrate 33 to the metal housing 311 on the side of the front end portion, it is possible to secure enough internal space to accommodate the lens array component 41, while maintaining the entire size to be small.

In addition, it is desirable that a radiation member 44, thermally connecting the circuit substrate 33 and the metal housing 311, be provided on the inner side of the top plate 34 including the cut-and-raised hole 342 in the metal housing 311. In this way, even in a case where dusts, having entered a gap between the metal housing 311 and the resin housing 312, reach the cut-and-raised hole 342 of the engagement convex portion 341, intrusion of dusts and the like can be prevented by the radiation member 44 provided in the inner side of the cut-and-raised hole 342. In addition, if the radiation member 44 is provided between the circuit substrate 33 and the metal housing 311, it is possible to release heat generated by the lens array component 41 and the like to the metal housing 311.

As illustrated in FIG. 4, the electrical connector 32 is provided on the side of the front end portion of the metal housing 311, and the fixing member 35 is linked to the side of the rear end portion of the metal housing 311.

The fixing member 35 has a plate-shaped base portion 351 and a cylindrical tube portion 352. A boot 36 to be connected to the resin housing 312 is provided in rear of the fixing member 35.

The tube portion 352 has a substantially cylindrical shape, and is provided so as to protrude rearward from the base portion 351. The tube portion 352 holds the optical cable 20 together with a caulking ring 37.

The procedure to hold the optical cable 20 using the fixing member 35 is, for example, as follows. That is, first, after peeling off the jacket 26, the optical fiber ribbon 21 of the optical cable 20 is inserted through the inside of the tube portion 352, while arranging the interposing layer 24 along the outer periphery surface of the tube portion 352. Then, the caulking ring 37 is arranged on the interposing layer 24 arranged on the outer periphery surface of the tube portion 352, thereby caulking the caulking ring 37. In this way, the interposing layer 24 is clamped to be fixed between the tube portion 352 and the caulking ring 37, and then the optical cable 20 is held to be fixed by the fixing member 35. Meanwhile, as described above, it is desirable that the optical cable 20 be fixed to the fixing member 35 so as to be further adhered thereto.

An end portion of the metal layer 25 of the optical cable 20 is, for example, bonded to the base portion 351 by soldering. Specifically, the metal layer 25 is arranged to cover the outer periphery of the caulking ring 37 (tube portion 352) in the fixing member 35 such that the end portion thereof is extended to one surface (rear surface) of the base portion 351 so as to be bonded by soldering. In this way, the fixing member 35 and the metal layer 25 are thermally connected to each other. Moreover, the rear end portion of the metal housing 311 is coupled with the fixing member 35 such that the metal housing 311 and the fixing member 35 are physically and thermally connected to each other. In other words, the metal housing 311, and the metal layer 25 of the optical cable 20 are thermally connected to each other, thereby further being thermally connected to the radiation member 44 via the top plate 34 of the metal housing 311.

As illustrated in FIGS. 4 and 5, the resin housing 312 is, for example, formed of a resin material such as polycarbonate in a rectangular tube shape, thereby covering the metal housing 311. An engagement concave portion 313 (first engagement portion) engaging with the engagement convex portion 341, which is provided on the top plate 34 of the metal housing 311, is provided on the inner surface of the resin housing 312 (see enlarged view in FIG. 5). The metal housing 311 and the resin housing 312 are relatively positioned by engaging the engagement convex portion 341 with the above-mentioned engagement concave portion 313. In addition, the resin housing 312 can be prevented from being deviated or detached from the metal housing 311, by engaging the engagement convex portion 341 with the engagement concave portion 313 as in the above.

The boot 36 is linked to the rear end portion of the resin housing 312, thereby covering the fixing member 35 attached to the rear end portion of the metal housing 311. The rear end portion of the boot 36 and the jacket 26 of the optical cable 20 are adhered to each other by an adhesive (not illustrated).

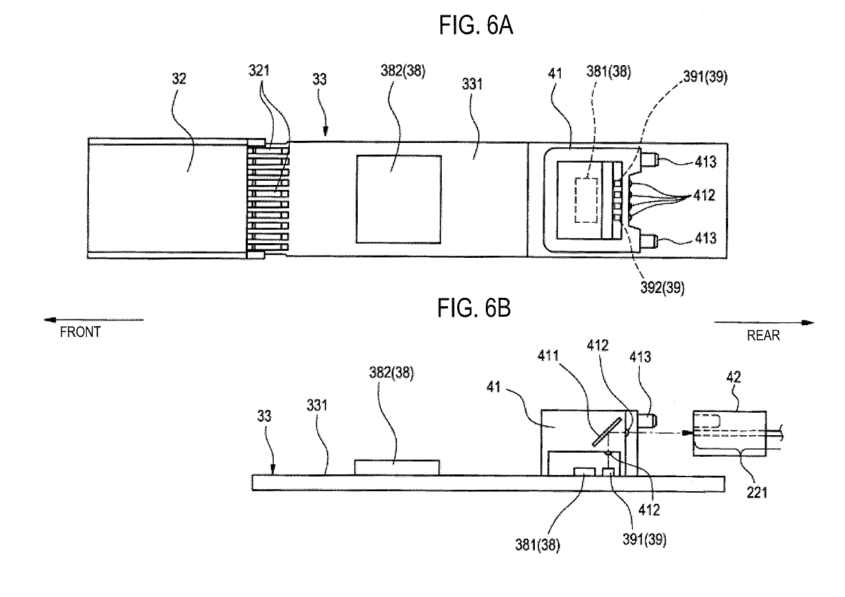

The electrical connector 32 is inserted into a connecting subject (personal computer and the like), while being an electrically connecting part to the connecting subject. The electrical connector 32 is arranged on the side of the front end portion (left end in FIG. 4) of the housing 31 so as to protrude forward from the housing 31. The electrical connector 32 is electrically connected to the circuit substrate 33 by a contact terminal 321 (see FIG. 6).

The circuit substrate 33 is accommodated in the internal space S of the metal housing 311. As illustrated in FIG. 6, a controlling semiconductor 38 and light receiving and emitting elements 39 (optical elements) are mounted on the circuit substrate 33. The circuit substrate 33 electrically connects the controlling semiconductor 38 and the light receiving and emitting elements 39. The circuit substrate 33 has a substantially rectangular shape with a predetermined thickness in a plan view. The circuit substrate 33 is, for example, an insulating substrate such as a glass epoxy substrate or a ceramic substrate, and circuit wiring is formed on the surface or inside thereof by gold (Au), aluminum (Al), copper (Cu) or the like. The controlling semiconductor 38 and the light receiving and emitting elements 39 are configured to be included in a photoelectric conversion unit. Further, a radiation sheet 43 (see FIG. 3) to be described below is arranged between the circuit substrate 33 and the metal housing 311.

The controlling semiconductor 38 includes a driving integrated circuit (IC) 381, or a clock data recovery (CDR) device 382 which is a waveform shaper. The controlling semiconductor 38 is arranged on the side of the front end of the mounting surface 331 on the circuit substrate 33. The controlling semiconductor 38 is electrically connected to the electrical connector 32.

As illustrated in FIG. 6, the light receiving and emitting elements 39 are configured to include a plurality (two in the example) of light emitting elements 391 and a plurality (two in the example) of light receiving elements 392. The light emitting elements 391 and the light receiving elements 392 are arranged on the side of the rear end of the mounting surface 331 on the circuit substrate 33. As the light emitting element 391, for example, a light emitting diode (LED), a laser diode (LD), a vertical cavity surface emitting laser (VCSEL) or the like can be employed. In addition, as the light receiving element 392, for example, a photo diode (PD) or the like can be employed.

The light receiving and emitting elements 39 are optically connected to the coated optical fiber 22 of the optical cable 20. Specifically, as illustrated in FIG. 6(B), the lens array component 41 is arranged on the circuit substrate 33 so as to cover the light receiving and emitting elements 39 and the driving IC 381. In addition, positioning pins 413 (see FIG. 6) are provided in the lens array component 41. Then, the lens array component 41 can be engaged with a connector component 42 to be positioned by engaging the positioning pins 413 with a positioning pin insertion hole provided in the connector component 42.

Tip end portions of the plurality (four in the example) of coated optical fibers 22 separated from the optical fiber ribbon 21 into single fibers are fixed onto the connector component 42. More specifically, the tip end portions of the coated optical fibers 22, which are respectively inserted one by one into a plurality (four in the example) of through holes provided in the connector component 42, are adhesively fixed to a concave portion (not illustrated) provided on a surface of the connector component 42. Further, in parts inserted at least into the through hole of the connector component 42 at the end portion 221 of the coated optical fiber 22, coating resins are removed so as to expose the optical fibers.

In the lens array component 41, a plurality of lens surfaces 412 are formed on an opposite surface of the connector component 42 and on an opposite surface of the light emitting elements 391 and the light receiving elements 392. In addition, in the upper surface center portion of the lens array component 41, a reflective surface 411 is formed along the width direction. Light emitted from the light emitting elements 391 is incident on the lens array component 41 through the lens surface 412 formed on the opposite surface. Then, after the light incident on the lens array component 41 is reflected by the reflective surface 411, the light is optically coupled with the end surface of the corresponding coated optical fiber 22 fixed to the connector component 42 by the lens surface 412 formed on the opposite surface of the connector component 42.

Meanwhile, light emitted from the end surface of the coated optical fiber 22 is incident on the lens array component 41 through the corresponding lens surface 412. Then, after the light incident on the lens array component 41 is reflected by the reflective surface 411, the light is received by the light receiving elements 392 through the lens surface 412 formed on the opposite surface of the light receiving elements 392. That is, the plurality of coated optical fibers 22 fixed to the connector component 42, and the light receiving and emitting elements 39 are optically connected to each other via the lens array component 41. Further, the plurality of lens surfaces 412 formed on the respective surfaces in the lens array component 41, for example, emit diffused light incident thereon as parallel light, and the lens surfaces 412 are collimate lenses condensing the parallel light incident thereon to be emitted. The aforementioned lens array component 41 is, for example, integrally molded by injection molding of a resin.

In the optical module 10 having the above configuration, if an electrical signal is input via the electrical connector 32, the controlling semiconductor 38 receives the electrical signal via wiring of the circuit substrate 33. The electrical signal input to the controlling semiconductor 38 is output to the light receiving and emitting elements 39 via the wiring of the circuit substrate 33 from the controlling semiconductor 38, after waveform shaping and the like is carried out by level adjustment or the CDR device 382. The electrical signal is converted into an optical signal in the light receiving and emitting elements 39 to which the electrical signal is input, thereby emitting the optical signal from the light emitting elements 391 to the coated optical fiber 22.

In addition, an optical signal transmitted through the optical cable 20 is incident on the light receiving elements 392. An optical signal incident thereon is converted into an electrical signal in the light receiving and emitting elements 39 so as to output the electrical signal to the controlling semiconductor 38 via the wiring of the circuit substrate 33. In the controlling semiconductor 38, the electrical signal is processed by a predetermined treatment, and then the electrical signal is output to the electrical connector 32.

The radiation sheet 43 is arranged between the circuit substrate 33 and the metal housing 311 (see FIG. 3). The radiation sheet 43 is a thermal conductor formed of a material having thermal conductivity and flexibility. The radiation sheet 43 is provided to be extended along the width direction of the circuit substrate 33 in a rear surface 332 (see FIG. 6) of the circuit substrate 33. The radiation sheet 43 is, for example, arranged below the light receiving and emitting elements 39. The upper surface of the radiation sheet 43 is physically and thermally connected to the rear surface 332 of the circuit substrate 33, while the lower surface thereof is physically and thermally connected to the inner side surface of the metal housing 311. The circuit substrate 33 and the metal housing 311 are thermally connected to each other by the radiation sheet 43 such that heat of the circuit substrate 33 is transferred to the metal housing 311.

As in the above, in the optical module 10 according to the embodiment of the invention, since the step portion 343 is provided on the side of the front end portion of the top plate 34 of the metal housing 311 in the connector module 30 as described above, even though dusts enter from a gap between the top plate 34 of the metal housing 311 and the resin housing 312, it is difficult for dusts to intrude into the side of the rear end portion from the step portion 343.

In addition, in the optical module 10 according to the embodiment of the invention, since the engagement convex portion 341, engaging with the engagement concave portion 313 provided on the inner surface of the resin housing 312, is provided by cutting and raising a part of the top plate 34 of the metal housing 311, the cut-and-raised hole 342 is formed at the part cut and raised. However, the above-mentioned step portion 343 is provided on the side of the front end portion of the connector module 30 from the cut-and-raised hole 342. Accordingly, a gap between the top plate 34 and the resin housing 312 on a side of the cut-and-raised hole 342 (a side of rear end portion of connector module 30) from the step portion 343 is narrower than a gap between the top plate 34 and the resin housing 312 on the side of the front end portion from the step portion 343. Consequently, even though dusts enter from a gap between the top plate 34 of the metal housing 311 and the resin housing 312, it is difficult for dusts to intrude into the side of the rear end portion from the step portion 343. Therefore, it is difficult for dusts to enter the internal space S from the cut-and-raised hole 342.

In addition, in the embodiment, since the step portion 343 is provided on the side of the front end portion from the internal space S (accommodation space) where the lens array component 41 is provided, it is difficult for dusts to enter the internal space S where the lens array component 41 is arranged due to the above-mentioned effect. Moreover, since the radiation member 44 is provided inside the cut-and-raised hole 342, even in a case where dusts, having entered a gap between the metal housing 311 and the resin housing 312, supposedly intrude into the cut-and-raised hole 342 of the engagement convex portion 341, it is possible to prevent dusts from intruding into the internal space S from the cut-and-raised hole 342 by the radiation member 44. In addition, since the aforementioned radiation member 44 is provided between the circuit substrate 33 and the metal housing 311, it is possible to radiate heat generated by the lens array component 41 and the like to the metal housing 311.

In addition, in the embodiment, the light receiving and emitting elements 39 and the coated optical fiber 22 are respectively different from each other in optical axis such that an optical signal emitted from one thereof is converted in the optical axis direction so as to be optically coupled to the other thereof by the reflective surface 411 of the lens array component 41 which is the optical coupling member. In addition, the positioning pins 413 formed on the lens array component 41 are formed to protrude toward a direction substantially parallel to an optical axis of the coated optical fiber 22. The positioning pins 413 of the lens array component 41 are fit into the connector component 42 so as to cause the coated optical fiber 22 and the light receiving and emitting element 39 to be optically coupled with each other by moving the connector component 42 holding the coated optical fiber 22 in a direction substantially parallel to the optical axis of the coated optical fiber 22. Since the protruding direction of the positioning pins 413 is substantially parallel to a surface direction of the circuit substrate 33, the connector component 42 can be connected to the positioning pins 413 along the surface of the circuit substrate 33, thereby obtaining improvement in efficiency (workability) of assembly work.

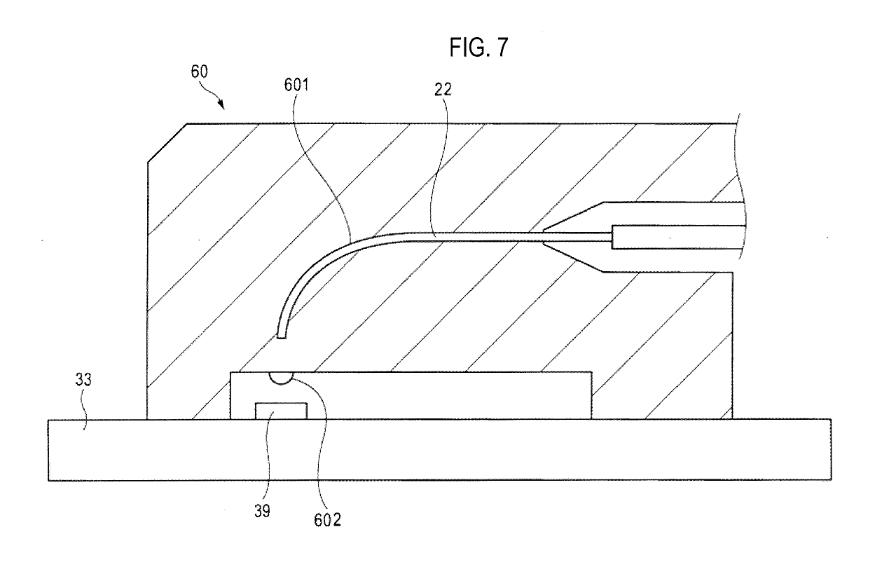

Further, as described above, the configuration, in which the lens array component 41 causes a light signal emitted from one of the light receiving and emitting elements 39 and the coated optical fiber 22, each of which has a different optical axis from the other, to be optically coupled with the other, is not limited to the embodiment employing the lens array component 41. A modified example is illustrated in FIG. 7. In the modified example illustrated in FIG. 7, in place of the lens array component 41 having the reflective surface 411, an arc-shaped optical fiber holding hole 414 in which it is possible to bend the tip portion of the coated optical fiber 22 in the optical axis direction of the light receiving and emitting elements 39 is formed in an optical ferrule member 60. As in the above, the optical axis of the coated optical fiber 22 and the optical axis of the light receiving and emitting elements 39 may be configured to be accorded by bending the coated optical fiber 22 using an optical fiber holding hole 601. Light emitted from the end surface of the coated optical fiber 22 becomes parallel light by a condensing lens 602 provided in the optical ferrule member 60 so as to be incident on the light receiving and emitting elements 39. In addition, light emitted from the light receiving and emitting elements 39 is condensed by the condensing lens 602 so as to be incident on the end surface of the coated optical fiber 22. Likewise the optical ferrule member 60, the optical coupling member and an optical fiber holding member may be integrally configured.

The above-described configuration can be arbitrarily chosen as a configuration of the optical coupling member. However, in a configuration where a light receiving and emitting element and a coated optical fiber, each of which has a different optical axis from the other, are optically coupled, the height of the optical coupling member may be greater than that of the electrical connector 32. In the aforementioned case, it is advantageous to have the configuration of the embodiment of the invention in a point where enough internal space can be secured to accommodate the aforementioned optical coupling member, while maintaining the small size of a module in its entirety.

Further, the optical module in the invention is not limited to each embodiment described above, and appropriate modifications and improvements can be made.

The present application is based on Japanese Patent Application No. 2011-289476, filed Dec. 28, 2011, the content of which is incorporated herein by reference.

1. An optical module comprising:
an optical cable including an optical fiber; and
a connector unit provided at an end portion of the optical cable,
wherein the connector unit includes,
an inner housing accommodating a circuit substrate in an internal space of the inner housing,
an optical element which is provided on the circuit substrate, and is optically connected to the optical fiber an electrical connector connected to a front end portion of the circuit substrate; and
an outer housing covering an outside of the inner housing,
wherein a step portion is provided on the inner housing,
wherein the internal space on a side of the front end portion from the step portion is narrower than the internal space on a side of a rear end portion from the step portion, and
wherein a predetermined gap is formed between the inner housing and the outer housing.

2. The optical module according to claim 1,
wherein an optical coupling member is provided on the circuit substrate, and the optical coupling member optically connects the optical fiber and the optical element,
wherein an optical axis direction of the optical fiber is different from an optical axis direction of the optical element, and
wherein the height of the optical coupling member is greater than the distance between the circuit substrate and the inner housing on the side of the front end portion.

3. The optical module according to claim 1,
wherein a sealing member, is attached between the inner housing and the electrical connector
wherein the sealing member has a smaller young's modulus than that of the inner housing, and
wherein the inner housing and the electrical connector are provided being in contact with the sealing member.

4. The optical module according to claim 1,
wherein a first engagement portion is provided on an inner surface of the outer housing, and a second engagement portion engaging with the first engagement portion is provided on a wall surface of the inner housing, and
wherein the step portion is provided on the side of the front end portion from the second engagement portion, and
wherein a gap between the wall surface and the outer housing on a side of a rear end portion of the connector unit from the step portion is narrower than a gap between the wall surface and the outer housing on a side of a front end portion of the connector unit from the step portion.

5. The optical module according to claim 1,
wherein the step portion is provided on a wall surface of the inner housing on the side of the front end portion from the internal space where the optical element is provided.

6. The optical module according to claim 5,
wherein a heat radiation member, thermally connecting the circuit substrate and the inner housing, is provided on the inner side of the wall surface including a hole of the inner housing which is made by the cut-and-raised portion.

7. The optical module according to claim 4,
wherein the second engagement portion is formed of a cut-and-raised portion of the wall surface of the inner housing.

8. The optical module according to claim 1,
wherein the inner housing has a cross-sectional U-shaped main body opened downwardly and a cross-sectional U-shaped base plate opened upwardly to form the internal space.

9. The optical module according to claim 2,
wherein the optical coupling member is a lens array component which is arranged on the circuit substrate so as to cover the optical element.

10. The optical module according to claim 9,
wherein positioning pins are provided in the lens array component, and the optical fiber is held in a connector component which has a positioning pin insertion hole, and
wherein the lens array component is engaged with the connector component to be positioned by engaging the positioning pins with the positioning pin insertion hole.

11. The optical module according to claim 10,
wherein the optical cable includes an optical fiber ribbon including a plurality of optical fibers, and tip end portions of the optical fibers separated from the optical fiber ribbon into single fibers are fixed onto the connector component.

12. The optical module according to claim 11,
wherein the optical fibers are coated optical fibers wherein the optical fibers are coated by coating resins, respectively, and
wherein in parts inserted at least into through holes of the connector component at the end portion of the coated optical fiber, the coating resins are removed so as to expose the optical fibers.
